(19) United States
(12) Patent Application Publication
(10) Pub. No.: US 2022/0258616 A1
(43) Pub. Date: Aug. 18, 2022

(54) Methods and Apparatus for Configuring an Electric Vehicle to Pull a Trailer

(71) Applicant: Atlis Motor Vehicles, Inc., Mesa, AZ (US)

(72) Inventors: Mark Hanchett, Mesa, AZ (US); Matt Wilkins, Portland, OR (US); Sean Lamont, Fort Myers, FL (US); William Tennison, Goodyear, AZ (US); Derek Duff, Apache Junction, AZ (US)

(73) Assignee: Atlis Motor Vehicles, Inc., Mesa, AZ (US)

(21) Appl. No.: 17/346,205

(22) Filed: Jun. 12, 2021

Related U.S. Application Data
(60) Provisional application No. 63/055,720, filed on Jul. 23, 2020.
(60) Provisional application No. 63/055,723, filed on Jul. 23, 2020.

(51) Int. Cl. B60L 15/20; G07C 5/00; H04W 4/80; G06F 13/42; G06F 16/23; H04L 12/40

(52) U.S. Cl. CPC B60L 15/20; G07C 5/008; H04W 4/80; B60R 16/0231; G06F 16/2379; H04L 12/40; G06F 13/4282

(57) ABSTRACT

A system for maintaining records regarding trailers to be pulled by electric vehicles. The system includes a server, a plurality of records for a plurality of trailers, and one or more electric vehicles. Each trailer includes an identifier. An electric vehicle that intends to pull a trailer may send the identifier for the trailer to the server. The server retrieves the record for the trailer using the trailer identifier and sends the record to the electric vehicle. The electric vehicle analyzes the record in light of the systems that control the operation of the electric vehicle. The electric vehicle determines parameters for controlling the operation of the systems in accordance with the data in the record. The electric vehicle sends the parameters to the respective systems and the systems operate in accordance with the parameters.

### BACKGROUND

Embodiments of the present invention relate to electric vehicles and trailers.

An electric vehicle may couple to and pull a trailer. An electric vehicle may include systems (e.g., suspension, brakes, drivetrain, electric motors, mirrors, steering) that may be adjusted to alter the driving characteristics of the electric vehicle while pulling the trailer. Drivers who use an electric vehicle to pull a trailer may benefit from a trailer that can identify itself to the electric vehicle and a server that maintains information regarding the physical and operational characteristics of the trailer.

### SUMMARY

Some of the various embodiments of the present disclosure relate to electric vehicles and trailers that are adapted to adjust their systems (e.g., suspension, brakes, drivetrain, electric motors, mirrors, steering, other component) to alter the driving characteristics of the electric vehicle and/or the trailer while the electric vehicle is coupled to and/or pulling the trailer.

Some of the various embodiments of the present disclosure include a server that maintains a database of information regarding the trailers that the electric vehicle may pull. The server and the electric vehicle may communicate with each other via wired and/or wireless electronic communication. Further, the trailer includes information that identifies (e.g., identifier, ID, serial number, trailer number) the trailer. The trailer and the electric vehicle may communicate with each other via wired and/or wireless electronic communication. A trailer may provide its identifier to the electric vehicle. The electric vehicle may provide the trailer identifier to the server. The server may use the trailer identifier to access the database. The server may provide information regarding the specific trailer to the electric vehicle. The electric vehicle and/or the trailer may adjust their systems in accordance with the information regarding the trailer.

### BRIEF DESCRIPTION OF THE DRAWING

Embodiments of the present invention will be described with reference to the figures of the drawing. The figures present non-limiting example embodiments of the present disclosure. Elements that have the same reference number are either identical or similar in purpose and function, unless otherwise indicated in the written description.

FIG. 1 is an example embodiment of an electric vehicle configuration system.

FIG. 2 is an example embodiment of an electric truck computer.

FIG. 3 is an example embodiment of a trailer computer.

FIG. 4 is a flowchart of an example method performed by the trailer, the electric truck and the server.

FIG. 5 is a flowchart of an example method performed by a user, the electric truck and the server.

FIG. 6 is an example record of data regarding a trailer.

FIG. 7 is a flowchart of an example method performed by the electric truck.

FIGS. 8 and 9 are an example embodiment of the ride height of an electric vehicle.

FIG. 10 is a first example embodiment of a ride height detector.

FIG. 11 is a diagram of signals transmitted and received by the first example embodiment of the ride height detector.

FIG. 12 is a second example embodiment of the ride height detector.

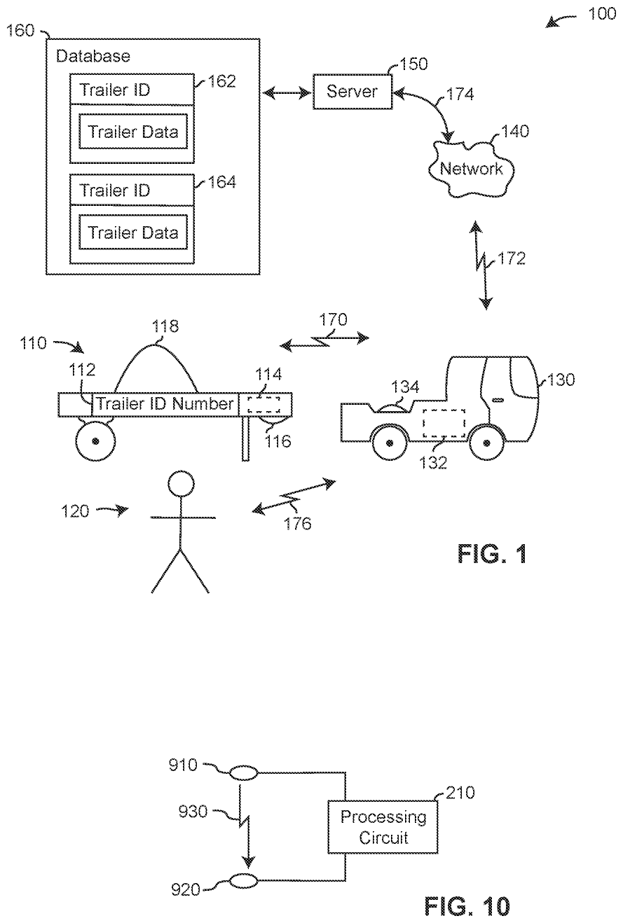

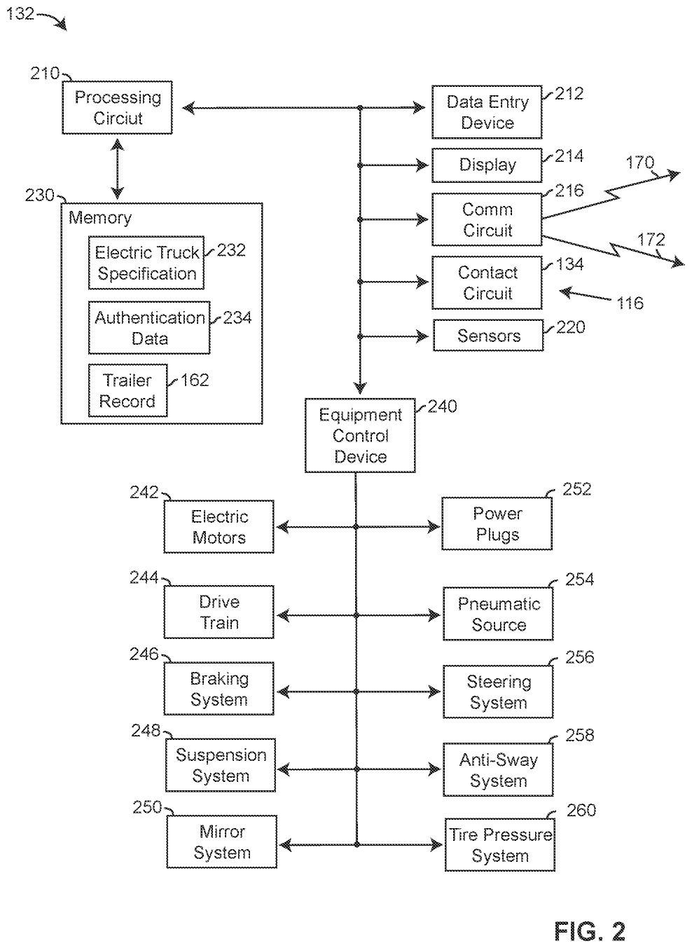

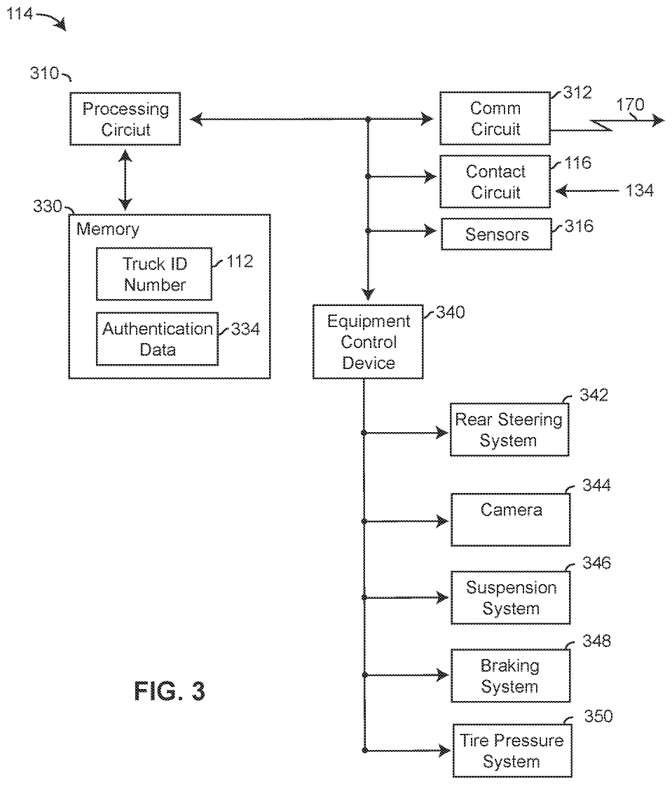

### DETAILED DESCRIPTION

### Overview

An example embodiment of the present disclosure relates to vehicles, including electric vehicles, trailers that are pulled by the vehicles, and a server that maintains a database regarding the characteristics of the trailers. Each trailer includes an identifier (e.g., ID, ID number, serial number, trailer number, trailer ID). The identifier identifies the trailer. The identifier may uniquely identify the trailer.

In an example embodiment, the identifier is provided to the vehicle. The identifier may be provided to the vehicle in a variety of ways including via a user and/or wired communication and wireless communication. The vehicle provides the identifier to the server. The server uses the identifier to access a database that stores information (e.g., data) regarding a plurality of trailers. The information regarding the trailer is associated with the identifier for a specific trailer. The information regarding the trailer may include information regarding the characteristics (e.g., physical, operational) of the trailer. The information associated with the trailer identifier may include information regarding the present task and/or cargo to be performed by the trailer. The server retrieves the information associated with the identifier and sends the trailer information to the vehicle. The vehicle and/or the trailer adjust their systems in accordance with the trailer information.

An electric truck may couple to a trailer. An electric truck may pull the trailer. An electric truck may push a trailer. An electric truck may perform the operations of coupling to a trailer, pushing and/or pulling a trailer in light of (e.g., in conformance to) the characteristics of the trailer. An electric truck may receive information regarding the characteristics of the trailer. An electric truck may use information regarding the characteristics of the trailer to aid in pulling and/or operating with the trailer.

An electric truck may adjust the manner in which it operates in accordance with the characteristics of the trailer to which it is coupled. An electric truck may conform to the characteristics of the trailer by adjusting the operation and/or structure of its own equipment. An electric truck may conform its equipment to cooperate with the trailer in light of the characteristics of the trailer.

For example, an electric truck may provide electrical power to a trailer in accordance with the characteristics of the electrical power needed by the trailer. An electric truck may provide air (e.g., pneumatic) pressure in accordance with the characteristics of the air pressure needed by the trailer.

Vehicle and/or Trailer Configuration System

In an example embodiment, a vehicle and/or a trailer configuration system 100 includes a trailer 110, an electric truck 130, a network 140, a server 150 and a database 160. The trailer 110 includes an ID number 112, a trailer computer 114 and a contact circuit 116. The trailer 110 may carry load 118. The electric truck 130 includes a truck computer 132 and a contact circuit 134. The human operator 120 may operate the electric truck 130. The database 160 includes information (e.g., records) regarding the characteristics of a plurality of trailers, including the characteristics of the trailer 110. Information regarding the characteristics of trailer 110 may be used to set the systems of the trailer 110 and/or the systems of electric truck 130.

### Trailer ID Number

The ID number 112 identifies the trailer 110. The ID number 112 may uniquely identify the trailer 110. The record regarding the characteristics of the trailer 110 may be associated with the ID number 112 and vice a versa. The ID number 112 may be printed on a portion of the trailer for visual inspection by an operator 120. The operator 120 may capture (e.g., remember, right down) the ID number 112 and provide the ID number 112 to the electric truck 130. The trailer computer 114 may store the ID number 112. The trailer computer 114 may provide the ID number 112 to the electric truck 130 via wireless communication (e.g., communication circuit 216, communication circuit 312) and/or via wired communication (e.g., contact circuit 116, contact circuit 134).

### Trailer Computer

In an example embodiment, the trailer computer 114 includes a processing circuit 310, a communication circuit 312, sensors 316, an equipment control device 340 and a memory 330. The memory 330 includes (e.g., stores) the ID number 112 and authentication data 334. The processing circuit 310 may read data from the memory 330, including the ID number 112 and/or the authentication data 334. The processing circuit 310 may write data in the memory 330 to store the data. The memory 330 may include a stored program for execution by the processing circuit 310 to perform the functions of the processing circuit 310.

In an example embodiment, communication circuit 312 may communicate wirelessly via short-range communication link 170. Communication circuit 312 may use any short-range communication protocol. The processing circuit 310 may retrieve the ID number 112 from the memory 330 and transmit the ID number 112 to the electric truck 130 via the communication circuit 312 and the short-range communication link 170. The processing circuit 310 may further receive information from the electric truck 130 via the communication circuit 312 and the short-range communication link 170.

### Vehicle Computer

In an example embodiment, the truck computer 132 includes a processing circuit 210, a data entry device 212, a display 214, a communication circuit 216, a contact circuit 134, sensors 220, an equipment control device 240, and a memory 230. The memory 330 includes (e.g., stores) the electric truck specifications 232 and authentication data 234. The processing circuit 210 may read data from the memory 230, including the electric truck specifications 232 and/or the authentication data 234. The processing circuit 210 may write data in memory 230 to store the data. The memory 230 may include a stored program for execution by the processing circuit 210 to perform the functions of the processing circuit 210.

### Equipment Control Device

An equipment control device (e.g., 240, 340) controls the systems of the trailer 110 or the electric truck 130. The equipment control device may determine parameters for setting the operation of a system of the electric truck 130 and/or the trailer 110. The equipment control device may set (e.g., adjust, alter, initialize, control) the physical and/or operational characteristics of a systems. The equipment control device may set the physical and/or operational characteristics of a system by providing the parameters of operation to the system. The one or more parameters may be provided to the system via electronic communication. The one or more parameters may include numbers. The one or more parameters may include one or more electrical signals (e.g., pulses, voltage, current, pulse width modulated signals). The equipment control device 240 may set the systems of the electric truck 130. The equipment control device 340 may set the systems of the trailer 110. The equipment control device may set one or more systems of the electric truck 130 and/or the trailer 110 during use (e.g., operation, movement) of the electric truck 130 and/or the trailer 110.

The equipment control device may transmit (e.g., send, write) the parameters to control the operation of the system in any manner using any communication protocol. For example, the equipment control device 240 may write (e.g., transfer) one or more parameters to one or more registers of a system using an address/data bus. In another example embodiment, the equipment control device 240 transfer one or more parameters to one or more systems using a serial bus. In another example embodiment, the equipment control device 240 transfers one or more parameters to one or more systems using wireless communication. In another example embodiment, the one or more parameters are transferred to the system via a controller area network (e.g., CAN Bus). The one or more systems may acknowledge receipt of the one or more parameters.

An equipment control device may determine the parameters for setting a system in accordance with the trailer data 162 (e.g., record 162) for the trailer 110. The equipment control device may receive the trailer data 162. The equipment control device may parse the trailer data 162. The equipment control device may analyze the trailer data to determine the parameters for each system. The equipment control device may further receive data from sensors for use in setting parameters for a system.

In an example embodiment, the functions of the equipment control device 240 and/or 340 are performed by the processing circuit 210 and/or 310 respectively so that the equipment control device 240 and/or 340 may be omitted.

Trailer and/or Vehicle Systems

The systems on the trailer 110 may be adjusted to operate with electric truck 130 and/or with the load 118 of the trailer 110. The trailer 110 may conform the operation of its equipment to cooperate with the electric truck 130 that pulls it and/or with the load 118 on the trailer. The electric truck 130 may use information regarding the trailer 110 and/or the load 118 to set and/or adjust the equipment of the trailer 110 and/or of the electric truck 130. The trailer 110 may use information regarding the electric truck 130 and load 118 to adjust its own equipment.

A system of trailer 110 and/or electric truck 130 may operate within a range. For example, a powertrain (e.g., electric motors 242 and drivetrain 244) and/or a braking system may deliver power for moving (e.g., accelerating) or slowing (e.g., deaccelerating) in a range that includes a low power (e.g., lightly loaded vehicle, light braking), a medium power (e.g., standard load, medium braking), and a high-power (e.g., heavy load, hard braking). A suspension system may operate in a range that includes low stiffness (e.g., light load), medium stiffness (e.g., standard loading), and high stiffness (e.g., heavy load). A steering system may operate in a range that includes minimum cornering (e.g., maximum turning radius, heavy load, high-speed), medium cornering (e.g., standard turning radius, standard load, standard speeds), and maximum cornering (e.g., minimum turning radius, front and back wheel steering, trailer steering, light load, low speed, parking maneuvers). An antisway system (e.g., sway bar, braking, acceleration, combinations thereof) may operate in a range that includes minimum sway suppression (e.g., light loads, slow speeds), medium sway suppression (e.g., standard loads, standard speeds), and maximum sway suppression (e.g., heavy loads, high speed).

A range of operation of a system may include more states (e.g., modes) than three (e.g., minimum, medium, maximum) as discussed in the above examples. The granularity of states in a range may be small (e.g., many states, many settings) or large (e.g., minimum, maximum). One or more different systems may cooperate with each other to increase the number of states of operation of the electric truck 130 and/or the trailer 110.

A system of the electric truck 130 and/or the trailer 110 may include electronic circuits (e.g., processing circuit) and/or electromechanical devices (e.g., relays) that translate the parameters to set the operation of the system.

In an example embodiment, the systems of the trailer 110 include a rear steering system 342, cameras 344 a suspension system 346, a braking system 348, a tire pressure system 350.

In an example embodiment, the systems of the electric truck 130 include electric motors 242, a drivetrain 244, a braking system 246, a suspension system 248, a mirror system 250, power plugs 252, a pneumatic source 254, a steering system 256, an anti-sway system 258 and a tire pressure system 260.

A steering system controls the orientation of the wheels to direct the direction of travel of electric truck 130 and/or the trailer 110. The rear steering system 342 controls the orientation of the wheels of the trailer 110 to steer the direction of travel of the trailer 110. The steering system 256 controls the orientation of the wheels of the electric truck 130 to steer the direction of travel of the electric truck 130. The rear steering system 342 may be engaged (e.g., enabled, operational) when backing the electric truck 130 while attached to the trailer 110. The rear steering system 342 enables the trailer 110 to maneuver around corners and/or in tights spaces. The rear steering system 342 may be set to take into account the length of the trailer 110. The processing circuit 310 may receive data from the truck computer 132 to coordinate steering of the electric truck 130 with steering of the trailer 110. Operational aspects of the rear steering system (e.g., 256, 342) that may be set include wheel angle, maximum angle of outward turn, maximum angle of inward turn and steering ratio.

The cameras 344 may be positioned at any location on the trailer 110. The field-of-view of the cameras 344 may be oriented in any direction to capture image data of the trailer and/or of the area surrounding the trailer. The cameras 344 may provide captured images, including video, to the electric truck 130 for viewing by the operator 120. In an example embodiment, the cameras 344 may be used to observe and/or monitor the coupling between the trailer 110 and the electric truck 130, the view in the rear (e.g., directly behind) of the trailer 110, the views to the sides of trailer 110, the blind spots of the electric truck 130, and/or the view forward of the trailer 110 including portions of the electric truck 130. Operational aspects of the cameras 344 that may be set include frame rate, direction of orientation, zoom, data compression, and light level.

A suspension system (e.g., 248, 346) includes any device and/or system that connects the body and/or the frame of the electric truck 130 or trailer 110 to the wheels of the electric truck 130 or trailer 110 respectively. The suspension system enables independent motion between the wheels and the body and/or frame of electric truck 130 and/or the trailer 110. The suspension system controls the static and/or dynamic response of the suspension. For example, the shocks of the suspension system may be adjusted to accommodate the weight of a load and/or load distribution on the electric truck 130 and/or the trailer 110. The suspension system may be set to provide a soft (e.g., bouncy) response, a medium response, or a stiff response. The suspension for sets (e.g., pairs) of wheels, or individual wheels, may be set and/or controlled independently. Operational aspects of the suspension system 248 that may be set include bump, rebound, ride height, spring rate, downforce level, damping, and corner and static weight.

A braking system (e.g., 246, 348) includes any device and/or system that inhibits the motion of a wheel. The braking system may inhibit the motion of the wheel by absorbing the energy produced by movement of the wheel and/or by using the movement of the wheel to produce electricity (e.g., regenerative braking). Operational aspects of the braking system that may be set include enabling or disabling regenerative braking, force applied by the brakes on the wheels, the timing of the application of the braking force, peak force applied, power dissipation, enabling or disabling brake cooling, smoothness, power, enabling or disabling boost, drag and anti-lock operation. The electric truck 130 may alter its braking and/or accelerating parameters to accommodate the gross weight of a trailer and/or the cargo specialty characteristics of the trailer.

The electric motors 242 include the electric motors that move the electric truck 130. The electric motors 242 may include two or more electric motors. The electric motors 242 may include two electric motors that drive the back wheels, two electric motors that drive the front wheels, or one electric motors for each wheel. Operational aspects of the electric motors 242 that may be set include start, stop, direction of rotation, speed of rotation, maximum RPMs, and torque.

The drivetrain 244 includes any device and/or system that transfers (e.g., couples) power to a wheel. The drivetrain 244 may include any device and/or system that couples a single electric motor to one or more wheels. The drivetrain includes any belts, flywheels, clutches, gears, gearboxes, differentials, torque converters, propeller shafts, transmission brakes, and/or portal gears used to transfer power from the electric motors 242 to one or more wheels of the electric truck 130. Operational aspects of the drivetrain 244 that may be set include power transfer ratio, gear selection, gear changes (e.g., shifting), torque reduction, torque multiplication, differential slip, gear reduction, gear ratios, differential ratio, differential lock, and differential unlock.

The mirror system 250 includes side view and/or review mirrors whether implemented as a mirror or a camera and a display. Operational aspects of the mirror system 250 that may be set include the angle of orientation with respect to the side of the electric truck 130, extension from the side of the electric truck 130, and height with respect to the electric truck 130. The mirrors and/or cameras of the mirror system 250 may be set (e.g., extend, retract) to conform to the characteristics of the width of the trailer. The mirrors and/or cameras of the mirror system 250 may be set to accommodate the length of the trailer 110. Mirrors and/or cameras of the mirror system 250 may be set to view along a length of the trailer and the door in the back of the trailer 110, if any. Mirrors and/or cameras may be set to capture images in the blind spots caused by the length and/or width of the trailer 110.

The power plugs 252 includes the electrical connections between the electric truck 130 and the trailer 110. The power plugs 252 provide electrical power to the trailer 110 for operation of the systems of trailer 110. The systems of the trailer may further include a refrigeration system and lights (e.g., signal indicators, body lights, caution lights). Operational aspects of the power plugs 252 that may be set include the voltage, the phase, the current and DC or AC operation. The electric truck 130 may set and/or alter the lighting configuration (e.g., exterior/interior lights illuminated) of the trailer 110 to accommodate the laws of the geographic location where the trailer is located. The electric truck 130 may set and/or alter the operation of the refrigeration of the trailer 110 based on external atmospheric temperature.

The pneumatic source 254 provides pneumatic power (e.g., air pressure) to the trailer 110. Pneumatic source 254 may provide pneumatic power to operate one or more systems of the trailer 110. Systems that use pneumatic power may include the braking system 348 and/or the tire pressure system 350. Operational aspects of the pneumatic source 254 that may be set include pressure, volume, rate of flow and temperature.

A tire pressure system (e.g., 260, 350) includes any device and/or system that monitors, increases and/or decreases the air pressure of a tire. A tire pressure system may operate to monitor, increase or decrease the air pressure in a tire while the electric truck 130 and/or the trailer 110 is in use. Operational aspects of the tire pressure system that may be set include maximum pressure, minimum pressure, rate of inflation and rate of deflation.

The anti-sway system 258 includes any device, system and/or combination of systems that operates to decrease (e.g., dampen) swaying and/or oscillations of the trailer 110 while in motion. The anti-sway system 258 may include a sway bar, dual cam sway control system, or any other type of weight distribution system. Anti-sway system 258 may also use sensors to monitor sway and actively operate the suspension system (e.g., 248, 364), the braking system (e.g., 246, 348), the drivetrain 244, and/or the tire pressure system (e.g., 260, 350) to reduce sway. Operational aspects of the anti-sway system 258 that may be set include any aspect of the suspension system, the braking system, the drivetrain 244, and/or the tire pressure system. Another operational aspect of the anti-sway system 258 that may be set includes the stiffness of the anti-sway bars.

### Contact Circuits

Contact circuit 116 comprises any type of a contact and/or conductors that while in physical contact with contact circuit 134 forms a circuit that allows sensors 316 to communicate with processing circuit 210.

### Transfer of Trailer Identifier

In an example embodiment, the operator 120 provides the ID number 112 to the electric truck 130. As discussed above, the ID number 112 is visible on a portion of the trailer. The operator 120 may view the ID number 112. The operator 120 may transfer the ID number 112 to the electric truck 130 via data entry device 212. The operator may remember, or write down, the ID number 112, enter the cab of the electric truck 130 and provide the ID number 112 to the truck computer 132 using data entry device 212. Data entry device 212 may include a keyboard. In the event that the display 214 is a touch-screen display, the operator 120 may use the data entry portion of the display 214 to provide the ID number 112 to the truck computer 132. Once in possession of the ID number 112, the truck computer 132 may send the ID number 112 to the server 150.

In an example embodiment, the operator provides the ID number 112 to the electric truck via a computing device. A computing device include a smart phone, a tablet, or any other device capable of receiving the ID number 112 and sending the ID number 112 to the electric truck 130 via wireless communication.

In an example embodiment, the operator 120 activates an application on a smart phone. The operator 120 uses a smart phone to take a picture of the ID number 112 on the trailer 110. The application analyzes the picture to determine the ID number 112. The application transmits the ID number 112 to the electric truck 130 via short-range communication link 176. The smart phone and the electric truck 130 may wirelessly communicate (e.g., transmit, sent) with each other using any communication protocol.

In an example embodiment, the operator 120 activates an application on a smart phone. The operator 120 uses the application to manually enter the ID number 112 into the application. The application transmits the ID number 112 to the electric truck via short-range communication link 176.

In another example embodiment, the trailer computer 114 establishes the short-range communication link 170 with the truck computer 132 using any wireless communication protocol. The processing circuit 310 accesses the memory 330 to retrieve the ID number 112. The trailer computer 114 transmits the ID number 112 to the truck computer 132 via the communication circuit 312 and the short-range communication link 170.

In another example embodiment, the trailer 110 is physically coupled to the electric truck 130 thereby bringing contact circuit 116 into physical contact with contact circuit 134. Physical contact between contact circuit 116 and contact circuit 134 establishes a circuit through which processing circuit 310 may communicate with processing circuit 210. The processing circuit 310 accesses the memory 330 to retrieve the ID number 112. The trailer computer 114 transmits the ID number 112 to the truck computer 132 via the circuit established by contact circuit 116 and contact circuit 134.

### Database of Trailer Data

As discussed above, the database 160 includes information regarding the characteristics of a plurality of trailers, including the characteristics of the trailer 110. An example embodiment the plurality of trailer data includes trailer data 162 and trailer data 164. Database 160 organizes trailer data in accordance with the ID number 112 (e.g., trailer ID) for each trailer respectively. In the event that the characteristics of a trailer change, the characteristics of the trailer may be updated in the database.

Database 160 may further store information regarding electric trucks. Information regarding electric trucks may be used to identify trailers that are compatible or not compatible with a specific electric truck.

Trailer data may include information regarding the physical characteristics (e.g., length, width, height, gross weight, maximum tongue weight, load capacity) of the trailer, trailer type (e.g., cargo specialty), operational information (e.g., weight, actual tongue weight), operational requirements (e.g., air pressure, electrical control, coupling type) and use characteristics (e.g., lighting configuration, light control protocol, truck-to-tractor clearances, anti-sway).

In an example embodiment, trailer data (e.g., 162, 164) includes length 612, width 614, height 616, weight 618, load capacity 620 gross weight 622, tongue weight 624, lighting configuration 626 (e.g., light location, light color, light intensity on the trailer), light control protocol 628, air pressure requirements 630, electrical requirements 632, coupler type (e.g., electrical, pneumatic) 634, truck-to-tractor clearances 636, trailer type (e.g., cargo specialty, liquid, gas, vehicle transport, heavy equipment) 638, camera type 640, actual weight 642, sway bar type 644, sway bar stiffness 646, load weight 648 and preferred communication protocol 650.

Responsive to receiving the ID number 112 from the electric truck 130, the server 150 accesses (e.g., reads, writes) database 160. The server 150 uses the ID number 112 as an index into the database 160 to locate the trailer data (e.g., record) associated with the trailer 110. The server 150 locates the trailer data associated with the ID number 112 and the trailer 110.

The server 150 may couple to the network 140. The network 140 may be a conduit (e.g., communication channel, communication link) for information. The network 140 may communicate (e.g., send, receive) data. The network 140 may communicate with the server 150. The network 140 may communicate with the electric truck 130. The network 140 may be used to transport data from the server 150 to the electric truck 130 and vice versa. The network 140 may employ wired and/or wireless communication links to communicate. The electric truck 130 and/or the server 150 may further communicate using wired and/or wireless communication links. The server 150 may communicate data via the network 140. The server 150 sends the trailer data (e.g., 160, 164) associated with the trailer 110 and the ID number 112 to the electric truck 130. The server 150 sends the trailer data to the electric truck 130 via the network 140. The server 150 establishes the communication link 174 with the network 140. The communication link 174 may be a long-range communication link. The network 140 establishes the short-range communication link 172 with the electric truck 130. The short-range communication link 172 may be a short-range communication link. The server 150 transmits the trailer data 162 to the electric truck 130 via the communication link 174, the network 140 and the short-range communication link 172. Upon receipt of the trailer data 162, the processing circuit 210 of the truck computer 132 may store the trailer data 162 in memory 230.

### Examples of Setting Vehicle and Trailer Systems

The operation of a system may be set by analyzing the data in the trailer data 162 from the perspective of the operations that are performed by the systems. The systems generally operate within range set by the parameters they receive. For example, suspension stiffness may be set to a soft range, a medium-range and a firm range. The trailer data 162 may be analyzed to determine the range in which the system should operate. Parameters determined during the analysis may be provided to the system to instruct the system to operate (e.g., work) in the range that is consistent with the data in the trailer data 162.

For example, the operation of the suspension system 248 and/or the suspension system 346 are directly affected by the weight of the electric truck 130, the weight of the trailer 110 and/or the weight of load 118. The weight of both the electric truck 130 and the trailer 110 are related to the load carried by the electric truck 130 and/or the load (e.g., 118) carried by the trailer 110. So, in determining the parameters for setting the range of operation of the suspension systems 248 and 346, the equipment control devices 240/340 and/or the processing circuits 210/310 must identify the weight related trailer parameters in the trailer data 162 then determine the parameters for setting the operation of the suspension systems 248 and 346.

Once the trailer data 162 has been analyzed with respect each system and the parameters for each system determined, the parameters may be sent to each system so that the system operates in accordance with the parameters.

The trailer data 162 for the trailer 110 may be used to adjust the braking system 246 of electric truck 130 and/or the braking system 348 of the trailer 110. The weight 618, load capacity 620 and the gross weight 622 is data that may be used to set the operation of the braking system 246 and/or the braking system 348. The weight 618 provides information regarding the unloaded weight of the trailer 110. The load capacity 620 provides information regarding how much weight the trailer 110 can carry. The gross weight 622 is the total amount of weight of the trailer and the cargo together. The actual weight 642, if available, may be used to set the timing of the application of the braking force, the peak force applied, the smoothness and whether boost is enabled or disabled. As discussed below sensors may also be used to determine an actual weight of the trailer which may be stored in actual weight 642 and also be used to set the braking system 246 and/or the braking system 348.

The gross weight 622 may provide an indication as to the possible setting of the peak force applied by the braking system. The gross weight 622 may also provide an indication as to whether the boost should or should not be enabled. The coupler type 634 may be used to determine whether electricity generated by regenerative braking in the trailer 110 can be transferred from the trailer 110 to the battery of electric truck 130. Electricity generated by generative braking on the trailer 110 may be transferred to the electric truck 130 if the electrical wiring of the coupler between the trailer 110 and electric truck 130 supports energy transfer from the trailer 110 to the electric truck 130. If the braking system 348 of the trailer 110 is an air brake system, the data of the air pressure requirements 630 may be used to set the air pressure provided to the trailer 110.

The trailer data 162 may be used to adjust the steering systems 256 and 342 of the electric truck 130 and the trailer 110 respectively. For example, the trailer type 638 may provide information regarding the structure of the trailer 110 that may inform the settings for the maximum angle of outward turn and the maximum angle of inward turn of the wheels for the trailer 110. The truck-to-tractor clearances 636 may provide information for setting maximum angle of outward turn, maximum angle of inward turn of electric truck 130 to limit the turning radius of the electric truck 130 to prevent contact between the trailer 110 and the back of the electric truck 130. The truck-to-tractor clearances 636 may provide information for setting maximum angle of outward turn, maximum angle of inward turn of trailer 110 to prevent the trailer 110 from crashing in to electric truck 130 as the trailer turns. The electric truck 130 may adjust (e.g., move up, move back) the mounting point with the trailer 110 to accommodate the truck-to-trailer clearance characteristics of the trailer 110. The length 612 may be used to set the steering ratio of electric truck 130 so that the longer the length of the trailer, the higher the steering ratio to provide more control when maneuvering in tight spaces.

The trailer data 162 may be used to set the cameras 344. For example, the height 616 and the width 614 of the trailer 110 may be used to set the orientation of the cameras 344 to provide images along the top and/or sides of the trailer 110. The length 612 and the width 614 may be used to set the orientation of the cameras to provide images in the blind spots of the electric truck 130. Since the cameras 344 are attached to the trailer 110, the coupler type 634 may be used to determine the amount of data that may be transferred from the trailer 110 to the electric truck 130. So, the coupler type 634 may be used to set the frame rate and/or the data compression of the cameras 344, and thereby, the amount of data sent by the cameras 344 to the electric truck 130. The camera type 640 may also be used to set the frame rate and/or data compression so that the amount of data sent by the cameras 344 can be handled by the electric truck 130.

The trailer data 162 may be used to set the suspension systems 248 and 346 of the electric truck 130 and the trailer 110 respectively. The weight 618, load capacity 620, gross weight 622 and actual weight 642 may be used to set the stiffness, the spring rate, the cornering and static weight, and the damping of the suspension system 224 or 346. The various weights (e.g., 618, 620, 624, 642) may be used to set the ride height of the trailer 110 and/or electric truck 130. The tongue weight 624 may be used to set the ride height of electric truck 130 and/or the sway bar stiffness 646 of the sway bar.

The trailer data 162 may be used to set the electric motors 242 and the drivetrain 244 of the electric truck 130. For example, the weight 618, load capacity 620, the gross weight 622, the tongue weight 624, and the actual weight 642 may be used to determine the power, the torque, gear ratios torque reduction, torque multiplication of the electric motors 242 and the drivetrain 244.

The trailer data 162 may be used to set the mirror system 250 of electric truck 130. The length 612, the width 614, and the height 616 may be used to set the angle of orientation, the extension, and the height of the mirrors and/or cameras of the mirror system 250.

The trailer data 162 may be used to set the power plugs 252 of the electric truck 130. For example, the coupler type 634, the electrical requirements 632, the light control protocol 628 and the lighting configuration 626 may be used to set the voltage, the phase, and the current provided by the electric truck 130 to the trailer 110 via the power plugs 252.

The trailer data 162 may be used to set the pneumatic source 254, which provides pneumatic power from the electric truck 130 to the trailer 110. For example, the trailer type 638, the coupler type 634 and the air pressure requirements 630 may be used to set the pressure, volume, rate of flow, and temperature of the pneumatic fluid (e.g., air) provided by the truck computer 132 to the trailer 110.

The trailer data 162 may be used to set the tire pressure system (e.g., 260, 350). For example, the weight 618, the load capacity 620, the gross weight 622, the tongue weight 624, the actual weight 642, the air pressure requirements 630, and the height 616 may be used to set the maximum pressure, the minimum pressure, the rate of inflation in the rate of deflation for the tires of the electric truck 130 and/or the trailer 110.

The trailer data 162 may be used to set the anti-sway system 258. For example, the length 612, the width 614, the height 616, the actual weight 642, the tongue weight 624, the sway bar type 644 and the sway bar stiffness 646 may be used to set stiffness of a sway bar, the tire pressure of the electric truck 130 and/or the trailer 110 and the suspension of the electric truck 130 and/or the trailer 110.

### Sensors

Sensors may detect (e.g., measure) one or more characteristics (e.g., physical characteristic) of the electric truck 130 and/or the trailer 110. Sensors may detect one or more characteristics of the operation of the electric truck 130 and/or the trailer 110. Sensors may detect one or more characteristics of an environment around the electric truck 130 and/or the trailer 110.

Sensors may include any type of sensor for measuring a physical characteristic of a vehicle, a trailer and/or the environment around the vehicle and/or trailer. A physical characteristic of a vehicle and/or a trailer may be a static (e.g., stationary, weight) and/or a dynamic characteristic (e.g., operational, during operation, acceleration, turning, rotating, so forth). Sensors may report the physical characteristics of a vehicle and/or a trailer as detected by the sensor. A sensor may report characteristics as data (e.g., analog, digital). A sensor may report detected physical characteristics to a computer.

The operational characteristics of a system of a vehicle and/or a trailer may be adjusted in accordance with the circumstances of operation of the vehicle and/or trailer. The systems of the vehicle and/or trailer may be adjusted in accordance with measurements made by the sensors of the vehicle and/or trailer. A computer may receive data from sensors, analyze the data to determine the characteristics (e.g., static) and/or characteristics of operation (e.g., dynamic) of the vehicle and/or the trailer. A computer may set the range of operation of one or more systems in accordance with the analysis of the data from the sensors. A computer may set the range of operation of one or more systems to improve safe operation of the vehicle and/or trailer. A computer may set the range of operation of one or more systems to improve efficiency of operation of the vehicle and/or trailer. A computer may set the range of operation of one or more systems to provide consistent operation of the vehicle and/or the trailer over a variety of conditions. Consistency of operation of the vehicle and/or the trailer may include how a driver perceives the operation of the vehicle and/or the trailer over a wide variety of conditions.

Sensors may include accelerometers (e.g., 1-axis, 2-axis, 3-axis), rotation sensors, torque sensors, pressure sensors, weight sensors, strain gages, gyroscopes (e.g., 1-axis, 2-axis, 3-axis), force sensors (e.g., load cells), distance sensors, magnetometers, and/or pressure sensors. One or more sensors, of any type, may be positioned at any location on the vehicle and/or the trailer. As discussed above, a sensor may provide data (e.g., information) related to the physical characteristic measured by the sensor. The physical characteristic measured by the sensor may relate to operation of the vehicle and/or the trailer.

For example, a rotation sensor may detect the rate of rotation of a wheel, and axle, and/or a driveshaft. The rate of rotation may be used to detect the linear speed of the vehicle, and/or trailer. A rotation sensor may detect the direction of rotation. The direction of rotation may be used to determine whether a vehicle and/or a trailer is moving forward or backward. Each wheel, each axle, and/or each driveshaft of the vehicle and/or trailer may be monitored by a different rotation sensor.

An accelerometer may detect a direction and/or rate of acceleration. An accelerometer coupled to a vehicle and/or a trailer may detect the rate of acceleration and/or deceleration of the vehicle and/or the trailer. The rate of acceleration may relate to the amount of weight of the vehicle and/or the trailer. The rate of deceleration may relate to the force provided for braking. The rate of deceleration may also relate to the weight of the vehicle and/or trailer.

An accelerometer may provide information regarding the direction of movement of the vehicle and/or the trailer. The rate of acceleration and/or deceleration provides information as to the magnitude of the forces acting upon the vehicle and/or the trailer. The rate of acceleration and/or deceleration may be measured for the vehicle and/or the trailer as a whole and/or separately. The rate of acceleration and/or deceleration may be measured for each wheel of the vehicle and/or a trailer.

An accelerometer may detect environmental forces that act on the vehicle. For example, an accelerometer may detect buffeting of the vehicle by wind, loss of traction due to slippery roads, collision, and movement of wheels with respect to the frame or chassis.

A torque sensor may detect (e.g., measure) a force that acts on a rotatable shaft (e.g., axle, drive shaft, motor shaft, wheel around and axle). A torque sensor may measure static and/or dynamic torque. A torque sensor may detect the rotational direction of a force that is applied to a rotating shaft. A torque sensor may report a magnitude of the torque acting on a rotating shaft. Information regarding the torque applied to a wheel and the resulting rotation (e.g., speed) of the wheel may be used to determine the load (e.g., weight) of the vehicle and/or trailer. The torque applied to a wheel and the resulting rotation of the wheel may provide information regarding the force required to overcome the inertia of the vehicle and/or trailer. A torque may be applied to a rotatable shaft to deaccelerate rotation of the shaft.

A pressure sensor detects a magnitude of a pressure. A pressure sensor may detect a hydraulic pressure, a pneumatic pressure, and/or a mechanical pressure. A pressure sensor may detect an amount of pressure applied to a mechanical device (e.g., brakes). Information from a pressure sensor may be used to detect an amount of the load (e.g., weight) of a vehicle and/or a trailer. For example, a pressure sensor may detect a force applied to a spring of a suspension system before and after a load is placed on a vehicle and/or a trailer. The amount of pressure applied to the spring may be used to determine the weight of the load. A weight sensor may detect the weight of an object or the weight of the load placed on a vehicle and/or trailer.

For example, a strain gauge may detect an amount of deformation of an object. An object may be deformed by a force applied to the object. A strain gauge may detect the amount of deformation therefore providing information to detect an amount of force applied to the object. A strain gauge may be positioned on a portion of a suspension system. An amount of deformation of the suspension system may be used to calculate the weight of the vehicle, the trailer, and/or the weight of a load on the vehicle and/or the trailer.

A pressure sensor, a weight sensor, and/or a strain gauge may be used to detect a tongue weight of a trailer. The tongue weight of the trailer may be used to detect a weight of the trailer. The pressure, weight, and/or strain on a tongue of a trailer, a hitch (e.g., receiver) on the vehicle and/or a fifth-wheel receiver on a vehicle may provide information as to the weight of the trailer and/or the load carried by the trailer. The pressure, weight, and/or strain on a hitch and/or a receiver may be measured before and after loading the trailer to determine a weight of a load. The tongue weight of the trailer after loading may be used to detect the weight of the load by determining the total weight of the trailer and subtracting the empty weight of the trailer.

Information regarding tongue weight and suspension deformation may be used to determine the weight of a trailer and/or a load on the trailer.

A gyroscope may detect a rate of rotation around a particular axis. A gyroscope may detect rotation around one or more axes. A three-axis gyroscope may be particularly useful in determining acceleration and/or position of a vehicle and/or a trailer. A gyroscope may be used to detect acceleration and/or deceleration in a direction (e.g., plane). A gyroscope may be used to detect a position of vehicle and/or a trailer. A gyroscope may be used to detect the rake (e.g., slope) of the vehicle and/or a trailer.

A distance sensor may detect a distance from one object to another object. A distance sensor may detect a distance between two objects. A distance reported by a distance sensor may be used to determine the height of the suspension of the vehicle and/or a trailer. A distance sensor may detect the distance between a frame of the trailer or the vehicle and the suspension of the trailer or the vehicle to calculate a distance between the trailer or the vehicle and the ground. A distance reported by a distance sensor may be used to determine the height of a vehicle and/or a trailer above the ground. A distance sensor may detect the height of a vehicle and/or a trailer prior to loading and the height of the vehicle and/or the trailer after loading to determine a weight of the load. A distance sensor may make regular measurements to determine a distance between two objects during operation of a vehicle and/or a trailer. For example, a distance sensor may make regular measurements of the height of a vehicle and/or a trailer with respect to the ground.

A pressure sensor may detect the hydraulic and/or pneumatic pressure of systems in the vehicle and/or trailer (e., brakes, tire inflation, suspension). The system that controls hydraulic and/or pneumatic pressure may be adjusted to increase, decrease or maintain hydraulic and/or pneumatic pressure in accordance with information from the pressure sensors. For example, the hydraulic pressure of braking fluid may be increased to provide additional force for braking. Pneumatic pressure of a tire may be increased or decreased.

As discussed above in several instances, the information reported by two or more sensors may be used to infer and/or calculate operation characteristics of a vehicle and/or a trailer. For example, the height of the suspension, the torque applied to wheels and the resulting acceleration may be used to calculate the weight of the load on the vehicle and/or the trailer.

Any suitable type of sensor may be used to provide data regarding the physical characteristic of the vehicle and/or a trailer. Data received from sensors and information calculated from the data may be used to adjust the systems of the vehicle and/or the trailer. Data from sensors may be used to adjust the operation of the systems of the vehicle and/or the trailer to improve the operation and/or safety of the vehicle and/or trailer.

For example, the sensors of the vehicle may be used to determine the weight of the vehicle and/or trailer. The weight may be determined for each wheel of the vehicle or each wheel and tongue of the trailer, thereby determining weight distribution across the frame of the vehicle and/or trailer. Knowing the weight and/or the distribution, a computer (e.g., processing circuit, processor) that controls and/or interfaces with the systems of the vehicle may adjust the operation of the systems. For example, if the vehicle has just been burdened with the load, the computer may adjust the suspension to be stiffer (e.g., more resistance) to maintain consistent ride characteristics (e.g., bounce, sway of vehicle). If the load causes a difference in the distribution of weight of the vehicle (e.g., more weight in back), the suspension in the back may be stiffened more than the suspension in the front. Changing the characteristics of the suspension may include changing the height of the suspension, the resistance to weight of the suspension and/or the pressure in a tire. The weight of the trailer and the distribution of the load may be used to determine the stiffness of the sway bar to reduce sway in the trailer.

When the load is removed, the sensors may detect the weight of the vehicle and/or the weight distribution. The suspension may be adjusted (e.g., less stiff) in accordance with removing the load. The height of the suspension and the pressure in the tires may further be adjusted.

The braking system may be adjusted in accordance with the weight of a vehicle and/or the weight of a trailer. For example, a vehicle that is not carrying a load and is not pulling a trailer may adjust its brakes to provide less braking power. When the sensors detected a load has been added to the vehicle, the braking power may be increased in accordance with the amount of the load. When the sensors detect that a trailer has been attached to the vehicle, the braking power may be further increased to match the detected load. A trailer may additionally include brakes. The sensors of the trailer and/or the vehicle may detect the load of the trailer and a computer in the trailer and/or the vehicle may adjust the braking power for the load detected in the trailer.

Braking power may further be distributed between the brakes of the front of the vehicle, the back of the vehicle, and/or the trailer. Braking power may be sent to separate wheels and/or sets of wheels in accordance with the distribution of the weight of the vehicle and/or the trailer. When the trailer is removed from the vehicle or the load of the vehicle and/or the trailer decreases, the braking power may be adjusted to decrease to the wheels in any combination to provide sufficient braking for the detected weight after disconnecting the trailer.

The power for acceleration of the vehicle may also be adjusted in accordance with the detected weight of the vehicle and/or the trailer. As the weight of the vehicle and/or the trailer increases, the computer may provide additional power to one or more sets of tires for consistent acceleration. A sensor may detect slippage of the wheel against the road. The power for acceleration of the vehicle may be further adjusted to compensate for slippage. For example, the power for acceleration may be increased for all wheels except the wheel that is slipping.

The trailer 110 may include sensors (e.g., 316) and systems (e.g., 342-350) that are separate from the sensors (e.g., 220) and systems (e.g., 242-260) of the electric truck 130. The electric truck 130 may include the sensors 220 to detect the characteristics of the trailer and adjust its systems in accordance with detecting. The trailer 110 may include the computer 114 that operates independently of the computer 132 of the electric truck 130. The computer 114 of the trailer 110 may cooperate with the computer 132 of the electric truck 130. The electric truck 130 may include the computer 132 that receives information from sensors 316 and/or 220 of the trailers 110 and/or the electric truck 130, and adjusts the systems in the trailer 110 and in the electric truck 130 in accordance with the data from the sensors 316 and/or 220.

In some instances, a trailer may sway as it is being pulled by a vehicle. A sensor (e.g., one or more gyroscopes) may detect the sway of a trailer. The computer may analyze the sway information with speed, torque, acceleration, and/or deceleration information to determine how and/or whether the sway of the trailer is related to speed, torque, acceleration and/or deceleration. The computer may adjust the suspension, speed, torque, acceleration, and/or deceleration to compensate for and/or reduce the sway.

For example, the computer may adjust the stiffness of a sway bar in accordance with the data from the sensors to reduce the sway of the trailer. The computer may adjust the braking system and/or braking algorithms that control the brakes to reduce the sway of the trailer. The computer may adjust the cornering behavior to prevent and/or reduce trailer sway. The computer may further adjust the acceleration/deceleration characteristics of the vehicle to reduce sway. Each system may be adjusted in accordance with the sway detected under particular conditions such as acceleration, deceleration, speed, road condition (e.g., bumps) or combination of conditions. In the event that sway is a result of environmental conditions (e.g., wind, slippage, road), the computer may adjust the various systems to compensate for the sway. In a vehicle that includes rear steering or a trailer whose wheels may be steered, the rear steering system of the vehicle and/or the trailer may be adjusted to decrease the sway of the trailer.

Sensors on a trailer may detect the length of the trailer. For example, sensors may be positioned along a length of the trailer to detect and report the length of the trailer. The length of the trailer may be reported to the computer in the vehicle. The vehicle may adjust systems (e.g., steering, mirrors, cameras) to accommodate the length of the trailer. Rear steering systems of the vehicle and/or the steering system of the trailer may be engaged when backing (e.g., maneuvering forward and/or backwards) the vehicle while attached to the trailer. Rear steering systems may take into account the length of the trailer.

Sensors on a vehicle and/or a trailer may detect the width of the trailer. The computer may adjust systems for compensating for the width of a trailer such as steering and/or the extension of side-mounted, rear-view cameras (e.g., mirrors).

As discussed above with respect to a vehicle, the sensors of a trailer may detect the load distribution of a trailer. The distribution of the load on a trailer may be used to determine whether the load is safely distributed on the trailer to reduce sway. An alert may be provided when improper or unsafe low distribution is detected. A computer may adjust systems to compensate, at least within certain limits, for uneven load distribution.

For example, the sensors 220 of the electric truck 130 may detect the characteristics of the electric truck 130 as discussed above. Sensors 316 of the trailer 110 may detect the characteristics of the trailer 110 and/or the load 118 as discussed above. The truck computer 132 may receive information from the sensors 220 and/or the sensors 316. The truck computer 132 may adjust the systems 242-260 and/or the systems 342-350 in accordance with the information from the sensors 220 and/or the sensors 316. The trailer computer 114 may receive information from the sensors 316 and/or the sensors 220. The trailer computer 114 may adjust the systems 342-350 and/or the systems 242-260 in accordance with the information from the sensors 316 and/or the sensors 320. The truck computer 130 and the trailer computer 114 may cooperate with each other to adjust the systems 242-260 and the systems 342-350.

In an example embodiment, the truck computer 132 may receive data from the sensors 220 and/or the sensors 316. The truck computer 132 may adjust the operation of the systems 242-260 of the electric truck 130 and the systems 242-250 of the trailer 110; however, the trailer computer 114 cannot adjust the systems 242-260 and must cooperate with the truck computer 132 two adjust the systems 342-350.

The sensors 220 may be positioned anywhere on the electric truck 130. The sensors 220 may detect the characteristics and/or physical properties of the electric truck 130 as discussed above. The sensors 220 may provide data to the truck computer 132. The truck computer 132 may make adjust the systems 242-260 and/or 342-350 in accordance with the data from the sensors 220.

The sensors 316 may be positioned anywhere on the trailer 110. The sensors 316 may detect the characteristics and/or physical properties of trailer 110 as discussed above. Sensors 316 may provide data to trailer computer 114 and/or the truck computer 132. The truck computer 132 and/or the trailer computer 114 may adjust systems 242-260 and/or 342-350 in accordance with the data from the sensors 220 and/or sensors 316. The trailer computer 114 may relay information from the sensors 316 to the truck computer 132.

In an example embodiment, the processing circuit 310 of the trailer computer 114 collects data from the sensors 316. The processing circuit 310 sends the data to the processing circuit 210 of the truck computer 132. The processing circuit 310 further collects data from the sensors 220. The processing circuit 310 uses the data from the sensors 220 and the sensors 316 to set and adjust the operating characteristics of the systems 242-260 and 342-350. The processing circuit 210 may send data for setting and/or adjusting the systems 342-352 the processing circuit 310. The processing circuit 310 with or without the cooperation of the equipment control device 340 sets the systems 342-350 in accordance with the data received from the processing circuit 210.

The processing circuit 210 may monitor the data from the sensors 220 and the sensors 316, via the processing circuit 310, during the operation of the electric truck 130 and the trailer 110. The processing circuit 210 may set and/or adjust any of the systems 242-260 and 342-350 during operation.

### Ride Height Detection

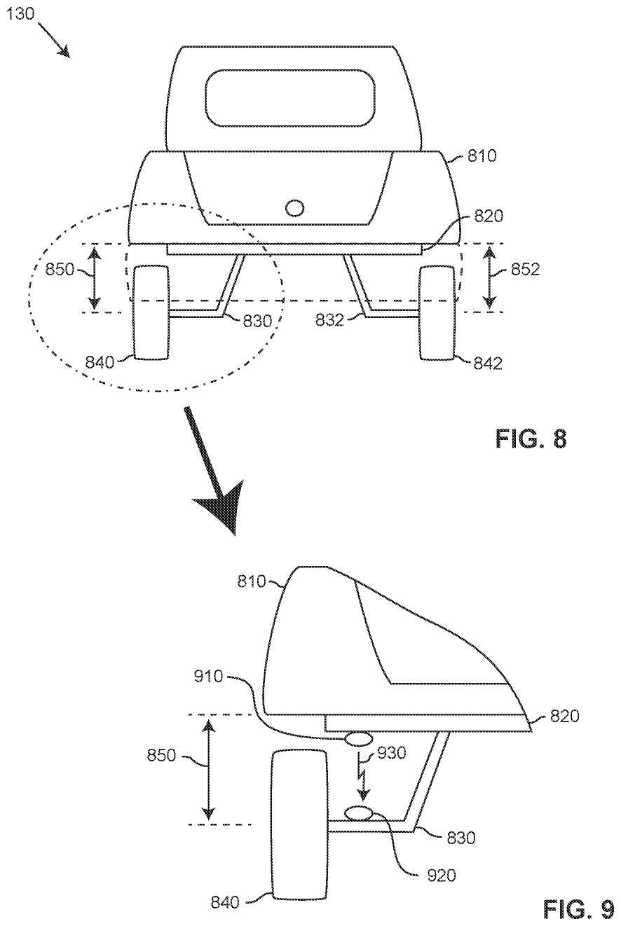

As discussed above, sensors may be used to detect the ride height of the electric truck 130 and/or the trailer 110. In example embodiments, as best shown in FIGS. 8-12, the electric truck 130 includes a body 810 and a frame 820. The suspension of the electric truck 130 includes a suspension arm 830 and a suspension arm 832. Suspension arm 830 is connected to the tire 840, while the suspension arm 832 is connected to tire 842. Sensors may be used to detect ride height 850, which is between the body 810 and the center of tire 840, and the ride height 852, which is between the body 810 and the center of the tire 842. The ride height may also be measured between the body 810 and/or the frame 820 and the suspension arm 830 and/or the suspension arm 830. The ride height 850 measures the ride height for the driver side of the vehicle, whereas the ride height 852 measures the ride height of the passenger side of the vehicle. Similar measurements may be made with respect to the suspension and tires of the trailer 110.

In an implementation, the sensors used to measure the ride height 850 include the transmitter 910 and the receiver 920. A separate transmitter and receiver may be used to determine the ride height 852. The transmitter 910 transmits a signal 930. The signal may be light (e.g., laser, LED), sound (e.g., ultrasound) and/or a radio wave. The receiver 920 receives the signal 930. The processing circuit 210 controls the transmission of the signal 930 by the transmitter 910. The receiver 920 informs the processing circuit 210 of the arrival of the signal 930 at the receiver 920. The timing of the transmission and reception of the signal 930 from the transmitter 910 to the receiver 920 respectively is shown in FIG. 11. At time T0, the processing circuit 210 instructs the transmitter 910 to transmit the signal 930. The signal 930 traverses the distance between the transmitter 910 and the receiver 920 and arrives at the receiver 920 at time T1. The receiver 920 reports the time T1 to the processing circuit 210. The difference between the time T1 and T0 represents the time-of-flight of the signal 930. The processing circuit 210 calculates the time of flight of the signal from the transmitter 910 to the receiver 920. Processing circuit 210 may determine the distance (e.g., d=rt) between the transmitter and the receiver, and therefore between the body 810 and the suspension arm 830. If the transmitter 910 is mounted on the frame 820, then the processing circuit 210 determines the distance between the frame 820 and the suspension arm 830. The processing circuit may then calculate the distance between the body 810 and/or the frame 820 and the center of the tire 840 and/or the ground.

In another example embodiment, the sensors used to measure the ride height 850 includes the transmitter 910, the receiver 920, and the reflector 1210. A separate transmitter, receiver and reflector may be used to determine the ride height 852. The transmitter 910, the receiver 920 and the reflector 1210 may be enclosed in an enclosure 1240 to protect them from the elements. In this example embodiment, the processing circuit 210 again controls the transmission of the signal 930 by the transmitter 910 and receives information regarding reception of the signal 930 by the receiver 920. However, the signal must traverse the distance from the transmitter 910 to the reflector 1210 and from the reflector 1210 to the receiver 920. In FIG. 12, the signal 930 reflects from the reflector 1210 to become the reflected signal 1230. The processing circuit 210 finds the difference between the time of transmission of the signal 930 and the time of reception of the reflected signal 1230. The processing circuit may then determine the distance (e.g., 2d=rt) between the transmitter 910 and the receiver 920. Depending on the type of signal used, the receiver 920 may detect a phase shift that is related to the distance traveled by the signal.

### In Operation

In operation, the electric truck 130 and/or the trailer 110 may use various methods to determine information regarding the electric truck 130 and/or the trailer 110 and to set the systems of electric truck 130 and the trailer 110 in accordance with the information.

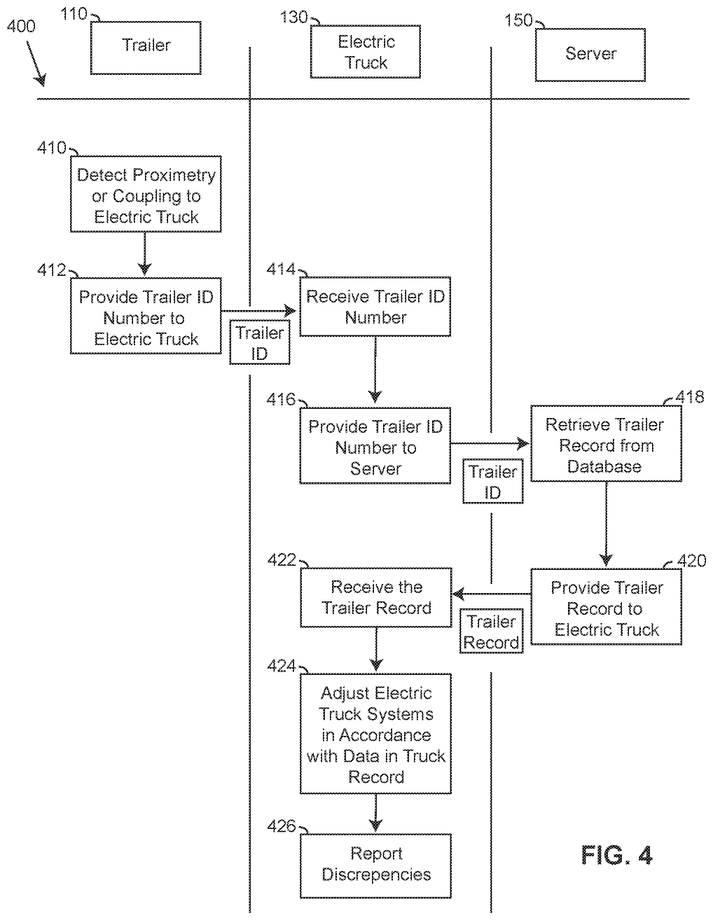

The trailer 110, the electric truck 130 and the server 150 may perform the method 400 to provide the electric truck 130 with information regarding the trailer 110, so that the electric truck 130 may adjust the systems 242-260 and/or the systems 342-350. The method 400, shown in FIG. 4, includes detect 410, provide 412, receive 414, provide 416, retrieve 418, provide 420, receive 422, adjust 424 and report 426.

In detect 410, the trailer 110 detects that the electric truck 130 is proximate to the trailer 110 or is coupled to the trailer 110. The trailer 110 may detect that it is coupled to the electric truck 130 via physical contact between the contact circuit 116 and the contact circuit 134. Contact between the contact circuit 116 and the contact circuit 134 creates a circuit that may be detected by the trailer 110 and/or the truck computer 132 to detect that they are coupled. The processing circuit 310 and the communication circuit 312 of the trailer computer 114 may also be used to determine whether it is proximate to the electric truck 130. If the trailer 110 is close enough to the truck computer 132 communicate wirelessly, the trailer 110 may transmit the ID number 112 to the electric truck 130.

In provide 412, the trailer 110 provides the ID number 112 to the electric truck 130. The ID number 112 may be provided to the truck via the contact circuit 116 and 134 or via the short-range communication link 170.

In receive 414, the electric truck 130 receives the ID number 112. The processing circuit 210 of the truck computer 132 may store the ID number 112 in the memory 230.

In provide 416, the electric truck 130 provides the ID number 112 to the server 150. In an example embodiment, the electric truck 130 transmits the ID number 112 to the server 150 via the short-range communication link 172, the network 140 and the communication link 174.

In retrieve 418, the server 150 uses the ID number 112 received from the database 160 the trailer record (e.g., 162) associated with the trailer ID number 112.

In provide 420, the server 150 provides the trailer record (e.g., 162) to the electric truck 130 via the communication link 174, the network 140 and the short-range communication link 172.

In receive 422, the processing circuit 210 receives the trailer record (e.g., 162) from the server 150. The processing circuit 210 stores the trailer record 162 in the memory 230 as trailer record 162.

In adjust 424, the processing circuit 310 uses the data from the trailer record 162 to set the systems 242-260 and/or the systems 342-350 as discussed above. As the processing circuit 210 is assessing the trailer record 162, the processing circuit 210 may detect any discrepancies between the data of the trailer record 162 and the data of the electric truck specifications 232. The processing circuit 210 may further receive data from the sensors 220 and/or the sensors 316. The processing circuit may confirm the data in the trailer record 162 and/or the data received from the sensors 220 and/or the sensors 316 with each other and also with the electric truck specifications 232. The processing circuit 310 may further set the systems 242-260 and/or the systems 342-350 in accordance with data from the sensors 220 and/or the sensors 316.

In report 426, the processing circuit 210 reports any discrepancies and/or inaccuracies between the data in the trailer record 162, the electric truck specifications 232 and/or the data measured by the sensors 220 and/or the sensors 316. The discrepancies may be reported to the server 150 via the short-range communication link 172, the network 140 and the communication link 174. The discrepancies may be reported to the operator 120 of the electric truck 130 by displaying information regarding the discrepancies on the display 214.

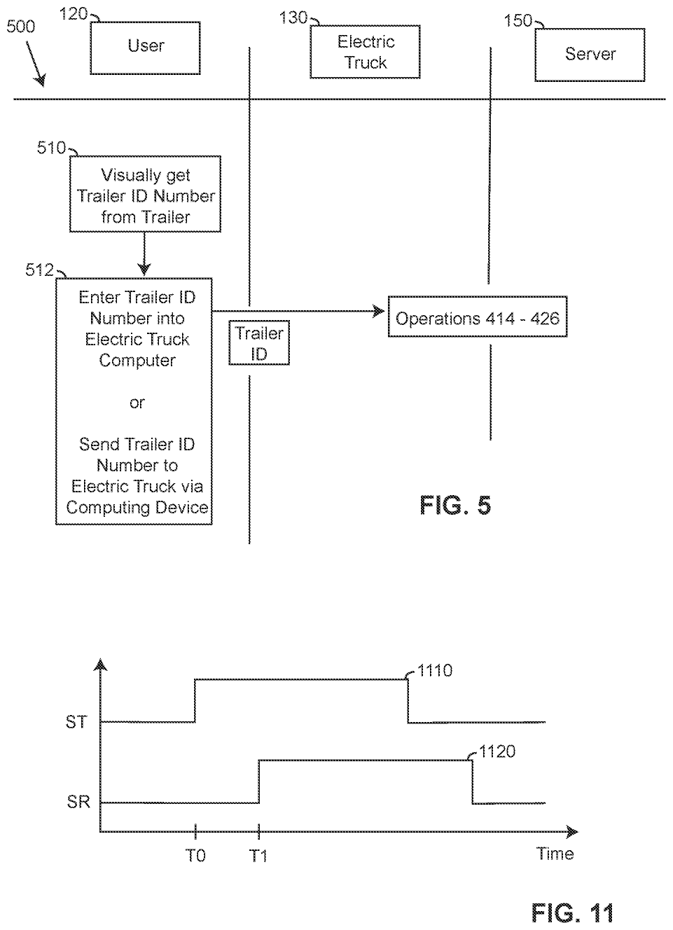

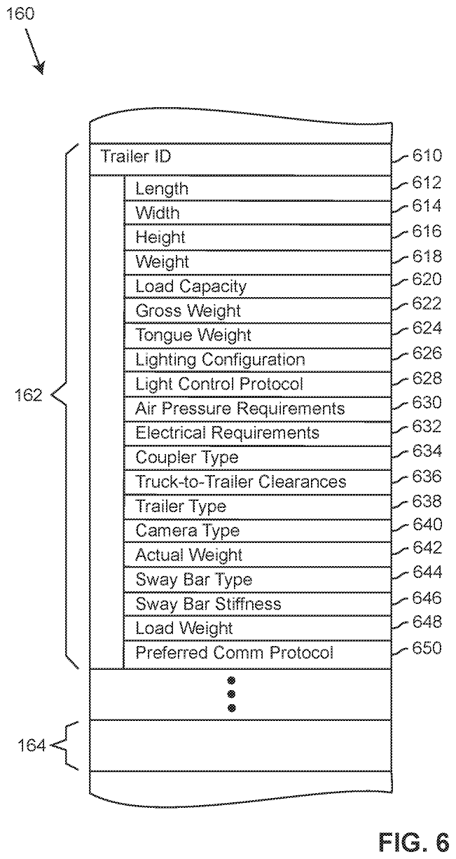

In another example embodiment, the operator 120, the electric truck 130 and the server 150 may perform the method 500 to provide the electric truck 130 with information regarding the trailer 110, so that the electric truck 130 may adjust the systems 242-260 and/or the systems 342-350. The method 500, shown in FIG. 5, includes visually get 510, enter 520 or send 520 and operations 414-426 from the method 400.

In visually get 510, the operator 120 physically goes to the trailer 110 and gets the ID number 112 from where ever it is inscribed or written on the trailer 110.

In enter 520, the user may either enter the ID number 112 manually into the truck computer 132 using the data entry device 212 or the operator 120 may enter the ID number 112 into a computing device (e.g., tablet, smart phone) in the possession of the operator 120 and within range to be able to wirelessly communicate with the communication circuit 216.

In a first embodiment of enter 520, the operator 120 either remembers or writes down the ID number 112 from the trailer 110. The operator 120 enters the cabin of the electric truck 130 and enters the ID number 112 into the truck computer 132 using the data entry device 212. In an example embodiment, the data entry device 212 is a keyboard. In another example embodiment, the data entry device 212 is a portion of the touchscreen of the display 214. After the user 120 has entered the ID number 112 using the data entry device 212, the processing circuit 210 may confirm that it has received the entry.

In a second embodiment of enter 512, the operator 120 may enter the ID number 112 into an application running on the computing device. The computing device may include a keyboard and/or a touchscreen for providing information to the computing device. The computing device establishes the short-range communication link 176 with the electric truck 130. The computing device transmits the ID number 112 to the processing circuit 210 via the short-range communication link 176 and the communication circuit 216. The processing circuit 210 may confirm receipt of the ID number 112 via the short-range communication link 176 to the computing device. The computing device may display confirmation of receipt to the operator 120. The computing device and the truck computer 132 may communicate with each other using any wireless communication protocol.

Once the truck computer 132 of the electric truck 130 has received the ID number 112, the electric truck 130 and the server 150 execute the operations 414-426 as described in the method 400.

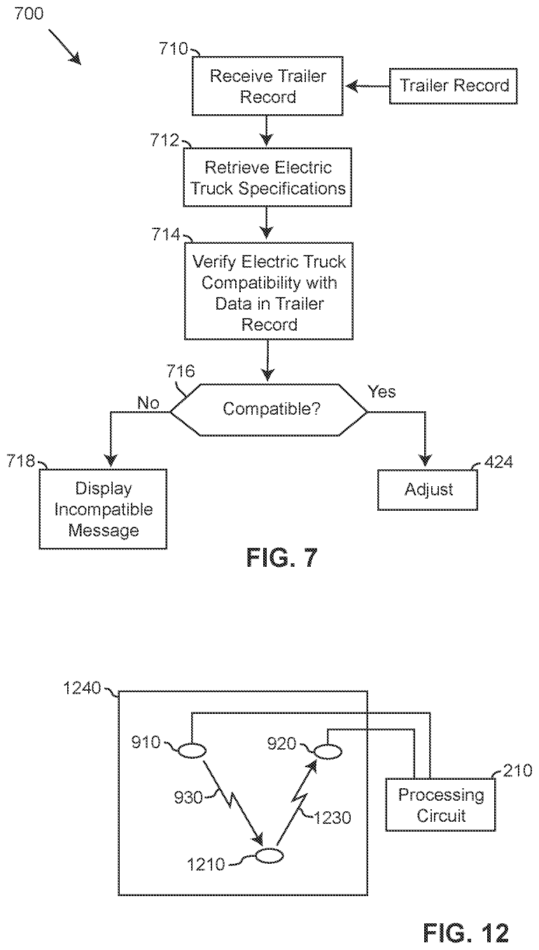

As discussed above, the truck computer 132 may detect discrepancies between the trailer record 162 and of the electric truck specifications 232. The method 700, shown in FIG. 7, is an example method for detecting discrepancies. The method 700 includes receive 710, retrieve 712, verify 714, compatible 716, display 718, and adjust 424 from the method 400.

In receive 710, the truck computer 132 receives trailer record 162. Receive 710 is the same as receive 422 in the method 400.

In retrieve 712, the processing circuit 210 accesses the memory 230 to retrieve the electric truck specifications 232.

In verify 714, the processing circuit analyzes the data in the trailer record 162 and the data in the electric truck specifications 232. The analysis may compare data from the trailer record 162 with data from the electric truck specifications 232. The analysis may combine data for comparison. The analysis may use the data to generate further data for comparison. During the analysis, the processing circuit 210 identifies data that is inconsistent and/or incompatible between the trailer record 162 and the electric truck specifications 232.

In compatible 716, the processing circuit 210 determines whether any inconsistent and/or incompatible information was found by verify 714. If the data in the trailer record 162 and the electric truck specifications 232 are not compatible, execution continues with display 718. If the data in the trailer record 162 and the electric truck specifications 232 are compatible, execution continues with adjust 424 of the method 400.

In display 718, the discrepancies found in verify 714 are reported. Display 718 is similar to report 426.

Adjust 424 of the method 700 is the same as adjust 424 of the method 400.

### Long-Range Communication

A long-range network or a long-range communication network refers to a network capable of communicating (e.g., transmitting, receiving) data (e.g., information) over distances measured in miles or hundreds of miles. A long-range network may include, for example, a cell phone network, a metropolitan area network, a wide area network, a cloud network or any other type of long-range network, including the Internet. A long-range network generally is a combination of wired and wireless networks, for example, a mobile device, such as an electric vehicle, may use a wireless communication link to access the long-range network. Electric vehicles may receive information from and provide information to servers via a long-range network. An electric vehicle may communicate via a long-range network using any suitable communication protocol.

### Short-Range Communication

An electric vehicle and a trailer may communicate with each other via a short-range network. The electric vehicle and the trailer may communicate directly with each other via a wireless short-range communication link. An electric vehicle and/or a trailer may communicate with a network via a short-range communication link. Through the network, the electric vehicle and/or the trailer may communicate with each other and/or with a server.

A short-range network and/or communication link refers to a network and/or a communication link capable of communicating over distances measured in feet, for example up to 500 feet. A short-range network generally is a wireless network of limited-range. A short-range network may also be referred to as a local network. Short-range wireless communication protocols may include, for example, WiFi (e.g., 802.11 a/b/g/n), Bluetooth and ZigBee. Although the range for short-range communication may be limited, the throughput (e.g., bit rate) may be high. An electric vehicle and/or a trailer may communicate via a short-range network using any suitable communication protocol.

### Security and Authentication

Long-range and short-range communication protocols may provide secure communication that are resistant to tampering such as man-in-the-middle attacks, eavesdropping and relay attacks. Devices that communicate via a long-range and/or short-range communication links may authenticate themselves to each other prior to communication and may encrypt communications to provide secure communication.

Although authentication and encryption are not explicitly disclosed in the flow charts or the written description of the present disclosure, authentication may be performed prior to any communication and encryption may be performed during any communication.

The foregoing description discusses implementations (e.g., embodiments), which may be changed or modified without departing from the scope of the present disclosure as defined in the claims. Examples listed in parentheses may be used in the alternative or in any practical combination. As used in the specification and claims, the words ‘comprising’, ‘comprises’, ‘including’, ‘includes’, ‘having’, and ‘has’ introduce an open-ended statement of component structures and/or functions. In the specification and claims, the words ‘a’ and ‘an’ are used as indefinite articles meaning ‘one or more’. While for the sake of clarity of description, several specific embodiments have been described, the scope of the invention is intended to be measured by the claims as set forth below. In the claims, the term “provided” is used to definitively identify an object that is not a claimed element but an object that performs the function of a workpiece. For example, in the claim “an apparatus for aiming a provided barrel, the apparatus comprising: a housing, the barrel positioned in the housing”, the barrel is not a claimed element of the apparatus, but an object that cooperates with the “housing” of the “apparatus” by being positioned in the “housing”.

The location indicators “herein”, “hereunder”, “above”, “below”, or other word that refer to a location, whether specific or general, in the specification shall be construed to refer to any location in the specification whether the location is before or after the location indicator.

Methods described herein are illustrative examples, and as such are not intended to require or imply that any particular process of any embodiment be performed in the order presented. Words such as “thereafter,” “then,” “next,” etc. are not intended to limit the order of the processes, and these words are instead used to guide the reader through the description of the methods.

What is claimed is:

1. A method for configuring an electric vehicle to pull a trailer, the method performed by the electric vehicle, the method comprising:
receiving a trailer identifier, the trailer identifier identifies the trailer to be pulled by the electric vehicle;
transmitting the trailer identifier to a server;
receiving a trailer record associated with the trailer identifier, the trailer record includes a data regarding one or more characteristics of the trailer;
determining one or more parameters in accordance with the data, the one or more parameters for setting an operation of a system of the electric vehicle; and
transmitting the one or more parameters to the system, whereby the system operates in accordance with the one or more parameters.

2. The method of claim 1, wherein receiving the trailer identifier comprises receiving the trailer identifier via a short-range wireless communication link.

3. The method of claim 1, wherein transmitting the trailer identifier comprises transmitting the trailer identifier via a short-range wireless communication link.

4. The method of claim 1, wherein determining comprises receiving the trailer record via a short-range wireless communication link.

5. The method of claim 1, wherein determining the one or more parameters comprises identifying the data in the trailer record that are associated with the system, determining how the data in the trailer record affects the operation of the system, and determining parameters to set the operation of the system in accordance with the data.

6. The method of claim 1, wherein determining the one or more parameters comprises determining a range of operation of the system in accordance with the data.

7. The method of claim 1, wherein transmitting the one or more parameters to the system comprises transferring the one or more parameters to the system via an address/data bus.

8. The method of claim 1, wherein transmitting the one or more parameters to the system comprises transferring the one or more parameters to the system via a serial bus.

9. The method of claim 1, wherein transmitting the one or more parameters to the system comprises transferring the one or more parameters to the system via a CAN bus.

10. The method of claim 1, wherein:
the system comprises a suspension system; and
determining comprises identifying data in the trailer record related to a weight of the trailer and determining the one or more parameters to set a stiffness of the suspension system.

11. The method of claim 1, wherein:
the system comprises a braking system; and
determining comprises identifying data in the trailer record related to a weight of the trailer and determining the one or more parameters to set a power of the braking system.

12. The method of claim 1, wherein:
the system comprises a mirror system; and
determining comprises identifying data in the trailer record related to a length and/or width of the trailer and determining the one or more parameters to an angle and/or extension of a mirror of the mirror system.

13. A system for managing and using a plurality of records regarding a plurality of trailers, one record for each trailer, the system comprising:
a server, the server having a database adapted to store the plurality of records;
an electric vehicle, the electric vehicle includes a vehicle computer and a plurality of systems that control an operation of the electric vehicle; wherein:
the electric vehicle receives a first identifier from a first trailer of the plurality, the first identifier associated with the first trailer;
the electric vehicle provides the first identifier to the server via a short-range communication link;
the server uses the first identifier to locate a first record associated with the first identifier;
the server transmits the first record to the electric vehicle;
the electric vehicle analyzes the first record in accordance with the plurality of systems;
the electric vehicle determines one or more parameters for one or more of the systems respectively; and
the electric vehicle sends the one or more parameters to the one or more systems respectively, the one or more parameters set an operation of the one or more systems respectively.

14. The system of claim 13 wherein:
the plurality of systems includes a suspension system; and
the one or more parameters set a stiffness of the suspension system in accordance with a weight of the first trailer.

15. The system of claim 13 wherein:
the plurality of systems includes a mirror system; and
the one or more parameters position one or more mirrors of the mirror system in accordance with at least one of a width, a length and a height of the first trailer.

16. The system of claim 13 wherein:
the plurality of systems includes a braking system; and
the one or more parameters set a force of the braking system in accordance with a weight of the first trailer.

17. The system of claim 13 wherein:
the plurality of systems includes a steering system; and
the one or more parameters set a turning radius of the electric vehicle in accordance with a truck-to-tractor clearance data.

18. The system of claim 13 wherein:
the plurality of systems includes an electric motor and a drivetrain; and
the one or more parameters set at least one of a power, a torque, a gear ratio, a torque reduction, and a torque multiplication of the electric motor and the drivetrain in accordance with a weight of the first trailer.

19. The system of claim 13 wherein:
the plurality of systems includes a pneumatic source; and
the one or more parameters set at least one of an air pressure and a rate of flow of the pneumatic source in accordance with at least one of a trailer type, a coupling type and air pressure requirements of the first trailer.
